(19) United States
(12) Patent Application Publication
(10) Pub. No.: US 2023/0301282 A1
(43) Pub. Date: Sep. 28, 2023

(54) LURE

(71) Applicant: GLOBERIDE, Inc., Tokyo (JP)

(72) Inventor: Hideyuki FURUYA, Tokyo (JP)

(21) Appl. No.: 18/114,040

(22) Filed: Feb. 24, 2023

(30) Foreign Application Priority Data
Mar. 24, 2022 (JP) 2022-047767

(51) Int. Cl. A01K 85/01

(52) U.S. Cl. CPC A01K 85/011

(57) ABSTRACT

A lure according to the disclosure comprises a main body having one surface and the other surface having different patterns. A pattern on one surface has a part provided with a pattern of the other surface.

### CROSS-REFERENCE TO RELATED APPLICATION

This application claims priority under 35 U.S.C. § 119 to Japanese Patent Application No. 2022-047767 filed on Mar. 24, 2022 in the Japanese Patent Office, the entire contents of which is hereby incorporated by reference.

### FIELD

The present disclosure relates to a lure used for fishing.

### BACKGROUND

In the related art, a known lure has an exterior pattern like a real fish. For example, JP 11-123037 A discloses a lure in which a hologram film is attached to a surface of a main body mimicking a form of a fish. JP 2015-47719 A discloses a lure in which a decorative layer having a scale pattern is printed by inkjet on a surface of a main body (base material).

In this manner, providing a lure with a surface pattern similar to that of a real fish makes the lure more appealing to fish to be caught, resulting in an increase in fishing result. Typically, such a lure has the same pattern on front and back surfaces. However, there is provided a lure which has a stronger appeal to fish because of its different patterns (asymmetrical pattern) on front and back surfaces.

### SUMMARY

When a lure having different patterns on front and back surfaces as described above is packaged for sale, the pattern on the unexposed side cannot be seen. To see the pattern, for example, a purchaser takes out the lure itself from the package, which is inconvenient for the purchaser. There is a package having a board with an opening. However, even in this case, the package needs to be turned, which may bother a purchaser. Furthermore, it is difficult to understand the pattern exactly from the opening. Still further, when the purchased lure is put in a lure case or the like, the pattern on the unexposed side cannot be seen, which makes it difficult to instantly determine the pattern on the back surface.

The disclosure has been made in light of the problems, and an object of the disclosure is to provide a lure comprising one surface and other surface having different patterns and configured to enable a user to understand the pattern of the other surface instantly.

To achieve the object, a lure according to the disclosure comprises a main body having one surface and the other surface with different patterns, and the pattern of the other surface is disposed on a part of the pattern on one surface.

In the lure having such a configuration, even when the lure is packaged or stored in a lure case or the like, the pattern of the unexposed side can be understood instantly, which eliminates the need for actions such as picking up the lure and turning it back.

According to this disclosure, it is possible to obtain a lure comprising one surface and the other surface having different patterns and configured to enable a user to understand the pattern of the other surface instantly.

### BRIEF DESCRIPTION OF THE DRAWINGS

FIG. 1 is a view showing an example of a pattern on one surface (front surface) of a lure according to an embodiment of the disclosure;

FIG. 2 is a view showing an example of a pattern on the other surface (back surface) of the lure shown in FIG. 1; and

FIG. 3 is a view showing an example of the lure shown in FIG. 1 after being packaged.

### DETAILED DESCRIPTION

Hereinafter, a lure according to an embodiment of the disclosure will be described.

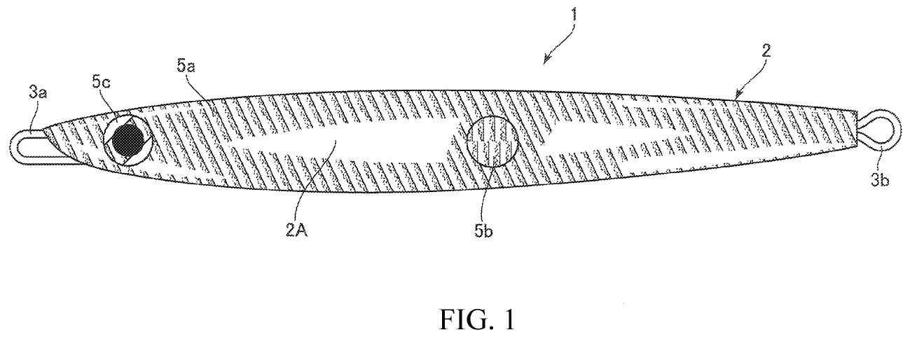

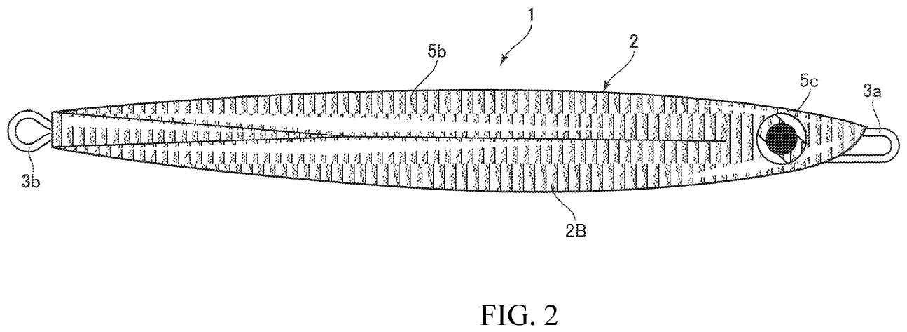

FIGS. 1 and 2 are views illustrating a lure according to an embodiment of the disclosure.

A lure 1 according to this embodiment is what is called a metal jig, having a main body 2 formed by a metal such as tungsten and having a shape mimicking small fish. The main body 2 is provided with eyes 3a and 3b on the front and the rear. A fish line from the rear is fastened to the eye 3a on the front, and a hook (fishhook) is fastened to the eye 3b on the rear. Note that another hook may be separately fastened to the eye 3a on the front.

The main body 2 comprises one surface 2A (a surface shown in FIG. 1 is referred to as “one surface” or “front surface” for convenience sake) and the other surface 2B (a surface shown in FIG. 2 is referred to as “the other surface” or “back surface” for convenience sake) having different patterns 5a and 5b. The main body 2 has an asymmetric pattern.

The patterns in this embodiment have an appearance similar to small fish scales and are formed by a hologram. With both surfaces having different patterns, the lure 1 has a stronger appeal to fish. Furthermore, similarly to a real fish, the both surfaces has an eye pattern 5c.

Forming patterns by a hologram enables luminance similar to that of small fish scales, which enhances the appeal to fish and increase fishing results. The aforementioned patterns may be printed on the main body 2. Alternatively, stickers having the patterns may be attached to the main body 2, or the patterns may be formed by hot stamping. The form of the different patterns on both surfaces and a method for providing such patterns are not limited to the aforementioned technique and may employ other methods.

As shown in FIG. 1, a part of the pattern 5a on the front surface 2A is provided with the pattern 5b of the back surface 2B. In other words, the pattern on the back surface 2B can be understood instantly when observing the front surface 2A.

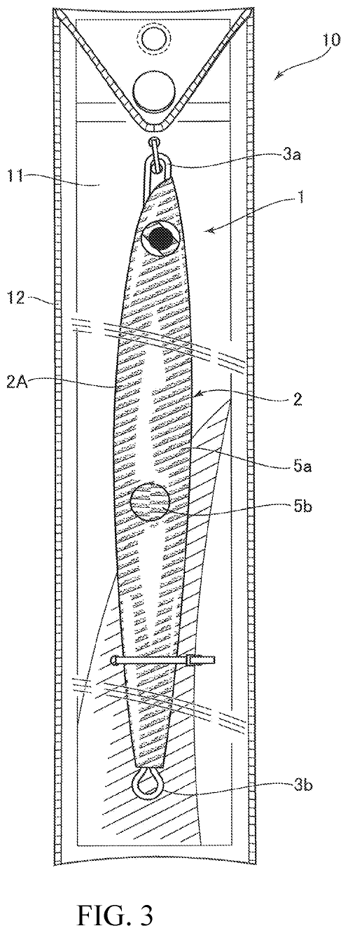

As shown in FIG. 3, when a packaged product 10 obtained by fixing the lure 1 to a board 11 and housing the lure 1 in a transparent packaging bag 12 is hung in a store for sale, a user can understand the pattern 5b on the back surface 2B by checking the pattern 5a on the front surface 2A. Accordingly, the user does not need to take the product 10 and turn it to see the back side and does not need to take out the lure 1 from the packaging bag 12. Even after the user puts the purchased lure in a lure case or the like, it is possible to understand the pattern on the back surface, so that there is no need to pick up the lure to check the back surface.

A method for providing the pattern 5b of the back surface is not particularly limited. The pattern 5b may be attached to the front surface 2A as a sticker in one spot or may be formed by printing or hot stamping, but it is preferable to provide the pattern 5b in such a manner that the pattern 5b does not easily peel off. In this case, the pattern 5b of the back surface is not particularly limited in position, but it is preferable that the pattern 5b is disposed within dotted lines in a central region of the main body 2 (In FIG. 1 the pattern 5b is disposed within circular solid lines). In other words, since fish feeding on small fish tends to bite a part with a pattern that changes, the pattern 5b of a comparable size to the eye pattern 5c is disposed as a dot in a central region. Accordingly, it is possible to produce such a secondary effect that the lure strikes fish more effectively (in actual tests, fishing results are increased).

Note that the size, shape, and arrangement of the pattern 5b of the back surface are not particularly limited and may be changed in various manners. For example, the pattern 5b may be put against the pattern 5a (background) and divided in up and down or oblique direction or scattered. However, if the pattern 5b of the back surface has too large an area, both surfaces have nearly the same pattern (or does not have asymmetric pattern), which decreases the appeal to fish. For this reason, the pattern 5b preferably accounts for 60% or less of the area of the front surface.

In regard to formation of a pattern of the back surface, it is preferable to provide the pattern of the other surface on both surfaces of the main body 2.

In this manner, providing a pattern of the other surface on both surfaces makes it possible to understand the pattern on the unexposed side even when a lure is in any situation. Furthermore, since the both surfaces have the pattern in one spot, it is possible to make the lure more appealing to fish.

The embodiment according to the disclosure has been described above, but the disclosure is not limited to the embodiment and may be modified in various ways.

The lure according to the disclosure may have any aspect as long as both surfaces have an asymmetric pattern and can be applied to lures other than metal jigs. In addition, the shape of the main body 2 and the positions of the eyes 3a and 3b can be changed appropriately. Furthermore, the pattern on each surface may employ various forms other than a hologram.

### REFERENCE SIGNS LIST

1 Lure
2 Main body
2A Front surface
2B Back surface
5a, 5b Pattern

What is claimed is:

1. A lure comprising a main body having one surface and the other surface with different patterns,
the pattern on one surface having a part provided with the pattern of the other surface.

2. The lure according to claim 1, wherein the patterns on both surfaces of the main body are holographic fish scale patterns.

3. The lure according to claim 1, wherein the pattern of the other surface disposed on the part of the pattern on one surface is disposed within dotted lines in a central region of the main body.

4. The lure according to claim 1, wherein the main body has both surfaces provided with the pattern of the other surface.

5. The lure according to claim 1, wherein the pattern of the other surface accounts for 60% or less of an area of one surface.
